(19) United States
(12) Patent Application Publication
(10) Pub. No.: US 2010/0253606 A1
(43) Pub. Date: Oct. 7, 2010

(54) PLASMA DISPLAY PANEL AND METHOD OF MANUFACTURING THE SAME

(76) Inventor: Byungjun Mun, Gumi (KR)

Correspondence Address: BIRCH STEWART KOLASCH & BIRCH, PO BOX 747, FALLS CHURCH, VA, 22040-0747, US

(21) Appl. No.: 12/679,223

(22) PCT Filed: Feb. 18, 2009
(86) PCT No.: PCT/KR2009/000764

§ 371 Date: Mar. 19, 2010

(30) Foreign Application Priority Data
Oct. 2, 2008 (KR) 10-2008-0097087

(51) Int. Cl. G09G 3/28; B05D 5/12; B05D 3/10

(52) U.S. Cl. 345/60; 427/64; 216/13

(57) ABSTRACT

A plasma display panel and a method of manufacturing the same are provided. The plasma display panel includes a substrate and a plurality of electrodes that are positioned substantially parallel to each other on the substrate. The plurality of electrodes include a first electrode in a first area of the substrate and a second electrode in a second area of the substrate outside the first area. A shape of a cross section of the first electrode is different from a shape of a cross section of the second electrode.

### TECHNICAL FIELD

Embodiments relate to a plasma display panel and a method of manufacturing the same.

### BACKGROUND ART

A plasma display panel includes a phosphor layer inside discharge cells partitioned by barrier ribs and a plurality of electrodes.

### DISCLOSURE OF INVENTION

When driving signals are applied to the electrodes of the plasma display panel, a discharge occurs inside the discharge cells. More specifically, when the discharge occurs in the discharge cells by applying the driving signals to the electrodes, a discharge gas filled in the discharge cells generates vacuum ultraviolet rays, which thereby cause phosphors between the barrier ribs to emit visible light. An image is displayed on the screen of the plasma display panel using the visible light.

### BRIEF DESCRIPTION OF THE DRAWINGS

FIGS. 1 and 2 illustrate a structure of a plasma display panel according to an exemplary embodiment;

FIG. 3 illustrates an exemplary method of driving a plasma display panel;

FIGS. 4 and 5 illustrate in detail an electrode;

FIG. 6 illustrates a relationship between a cross-sectional area of an electrode and an erroneous discharge;

FIGS. 7 and 8 illustrate cross sections of first and second electrodes;

FIGS. 9 and 10 illustrate electrodes on a rear substrate;

FIGS. 11 to 13 illustrate first and second areas; and

FIGS. 14 to 18 illustrate a method of manufacturing a plasma display panel.

### MODE FOR THE INVENTION

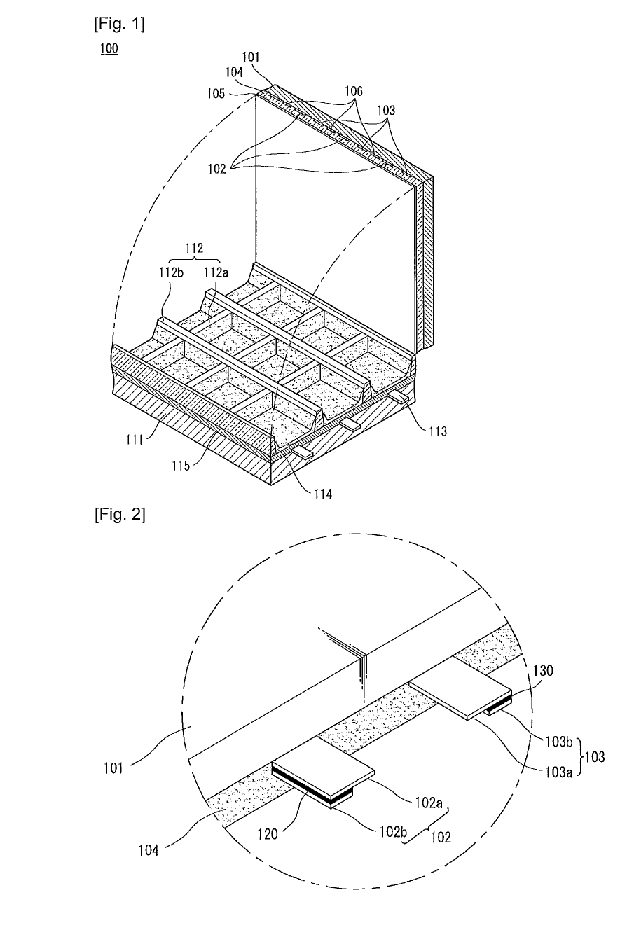

FIGS. 1 and 2 illustrate a structure of a plasma display panel according to an exemplary embodiment.

As shown in FIG. 1, a plasma display panel 100 may include a front substrate 101 on which a plurality of display electrodes 102 and 103 are positioned and a rear substrate 111 on which an address electrode 113 is positioned to cross the display electrodes 102 and 103. The display electrodes 102 and 103 may be scan electrodes and sustain electrodes.

An upper dielectric layer 104 may be formed on the scan electrode 102 and the sustain electrode 103 to limit a discharge current of the scan electrode 102 and the sustain electrode 103 and to provide insulation between the scan electrode 102 and the sustain electrode 103.

A protective layer 105 may be formed on the upper dielectric layer 104 to facilitate discharge conditions. The protective layer 105 may be formed of a material having a high secondary electron emission coefficient, for example, magnesium oxide (MgO).

A lower dielectric layer 115 may be formed on the address electrode 113 to provide insulation between the address electrodes 113.

Barrier ribs 112 of a stripe type, a well type, a delta type, a honeycomb type, etc. may be formed on the lower dielectric layer 115 to partition discharge spaces (i.e., discharge cells). Hence, a first discharge cell emitting red light, a second discharge cell emitting blue light, and a third discharge cell emitting green light, etc. may be formed between the front substrate 101 and the rear substrate 111.

The barrier rib 112 may include first and second barrier ribs 112a and 112b crossing each other. Heights of the first and second barrier ribs 112a and 112b may be different from each other. The first barrier rib 112a may be substantially parallel to the scan electrode 102 and the sustain electrode 103, and the second barrier rib 112b may be substantially parallel to the address electrode 113.

The height of the first barrier rib 112a may be less than the height of the second barrier rib 112b. Hence, in an exhaust process and a process for injecting a discharge gas, an impurity gas in the panel 100 may be efficiently exhausted to the outside of the panel 100, and the discharge gas may be uniformly injected. Each of the discharge cells partitioned by the barrier ribs 112 may be filled with the discharge gas.

A phosphor layer 114 may be formed inside the discharge cells to emit visible light for an image display during an address discharge. For example, first, second, and third phosphor layers that respectively generate red, blue, and green light may be formed inside the discharge cells.

FIG. 1 shows that the upper dielectric layer 104 and the lower dielectric layer 115 each have a single-layered structure. At least one of the upper dielectric layer 104 and the lower dielectric layer 115 may have a multi-layered structure.

While the address electrode 113 may have a substantially constant width or thickness, a width or thickness of the address electrode 113 inside the discharge cell may be different from a width or thickness of the address electrode 113 outside the discharge cell. For example, a width or thickness of the address electrode 113 inside the discharge cell may be greater than a width or thickness of the address electrode 113 outside the discharge cell.

FIG. 2 shows that the scan electrode 102 and the sustain electrode 103 each have a multi-layered structure. For example, the scan electrode 102 and the sustain electrode 103 may include transparent electrodes 102a and 103a and bus electrodes 102b and 103b on the transparent electrodes 102a and 103a.

The bus electrodes 102b and 103b may be formed of an opaque material, for example, at least one of silver (Ag), gold (Au) and aluminum (Al). The transparent electrodes 102a and 103a may be formed of a transparent material, for example, indium-tin-oxide (ITO).

When the scan electrode 102 and the sustain electrode 103 each include the transparent electrodes 102a and 103a and the bus electrodes 102b and 103b, black layers 120 and 130 may be formed between the transparent electrodes 102a and 103a and the bus electrodes 102b and 103b so that external light is prevented from being reflected by the bus electrodes 102b and 103b.

The transparent electrodes 102a and 103a may be omitted in the scan electrode 102 and the sustain electrode 103. The scan electrode 102 and the sustain electrode 103, in which the transparent electrode is omitted, may be referred to as an ITO-less electrode.

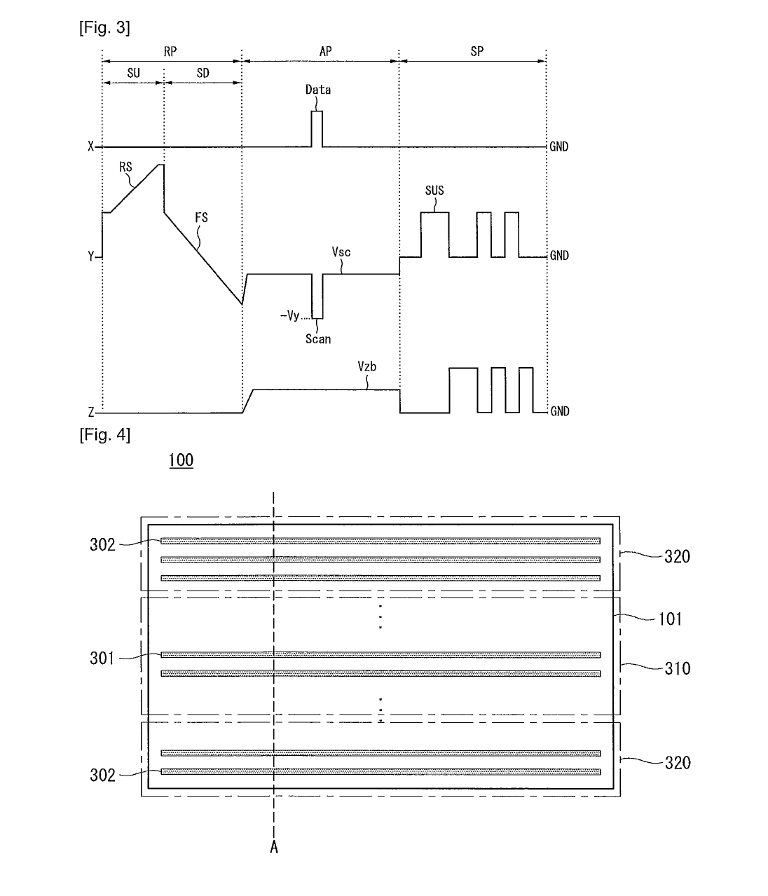

FIG. 3 illustrates an exemplary method of driving a plasma display panel.

As shown in FIG. 3, a rising signal RS and a falling signal FS may be supplied to the scan electrode Y during a reset period RP for initialization of at least one subfield of a plurality of subfields of a frame.

More specifically, the rising signal RS may be supplied to the scan electrode Y during a setup period SU of the reset period RP, and the falling signal FS may be supplied to the scan electrode Y during a set-down period SD following the setup period SU. The rising signal RS may generate a weak dark discharge (i.e., a setup discharge) inside the discharge cells. Hence, the remaining wall charges may be uniformly distributed inside the discharge cells. The falling signal FS may generate a weak erase discharge (i.e., a set-down discharge) inside the discharge cells. Hence, the remaining wall charges may be uniformly distributed inside the discharge cells to the extent that an address discharge occurs stably.

During an address period AP following the reset period RP, a scan bias signal Vsc having a voltage greater than a minimum voltage of the falling signal FS may be supplied to the scan electrode Y. A scan signal Scan falling from the scan bias signal Vsc may be supplied to the scan electrode Y during the address period AP.

A pulse width of a scan signal supplied to the scan electrode during an address period of at least one subfield of a frame may be different from pulse widths of scan signals supplied during address periods of other subfields of the frame. A pulse width of a scan signal in a subfield may be greater than a pulse width of a scan signal in a next subfield. For example, a pulse width of the scan signal may be gradually reduced in the order of 2.6 μs, 2.3 μs, 2.1 μs, 1.9 μs, etc. or may be reduced in the order of 2.6 μs, 2.3 μs, 2.3 μs, 2.1 μs . . . 1.9 μs, 1.9 μs, etc. in the successively arranged subfields.

When the scan signal Scan is supplied to the scan electrode Y, a data signal Data corresponding to the scan signal Scan may be supplied to the address electrode X. As the voltage difference between the scan signal Scan and the data signal Data is added to a wall voltage resulting from the wall charges produced during the reset period RP, an address discharge may occur inside the discharge cells to which the data signal Data is supplied.

During a sustain period SP following the address period AP, a sustain signal SUS may be supplied to at least one of the scan electrode Y or the sustain electrode Z. FIG. 3 shows that the sustain signals SUS are alternately supplied to the scan electrode Y and the sustain electrode Z. As the wall voltage inside the discharge cells selected by the generation of the address discharge is added to a sustain voltage of the sustain signal SUS, every time the sustain signal SUS is supplied, a sustain discharge (i.e., a display discharge) may occur between the scan electrode Y and the sustain electrode Z.

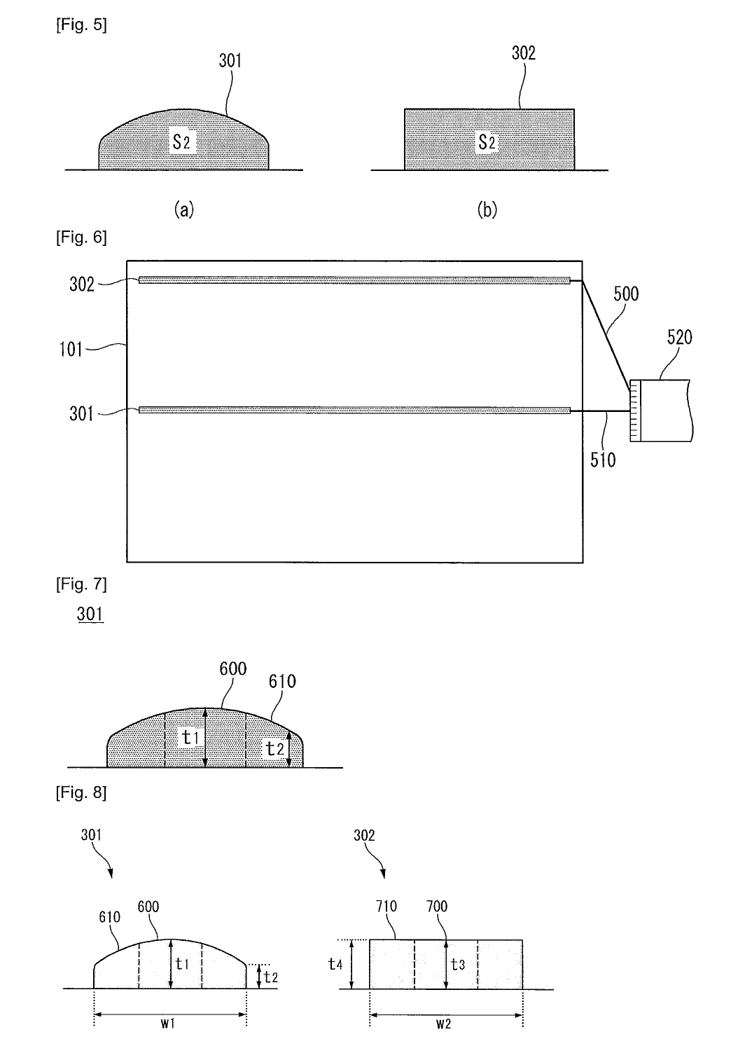

FIGS. 4 and 5 illustrate in detail an electrode.

As shown in FIG. 4, a first electrode 301 may be positioned in a first area 310 of a substrate 101, and a second electrode 302 may be positioned parallel to the first electrode 301 in a second area 320 outside the first area 310. The substrate 101 may be the front substrate of the plasma display panel 100, and the first and second electrodes 301 and 302 may be the same kind of electrode. For example, the first and second electrodes 301 and 302 may be scan electrodes or sustain electrodes.

In FIGS. 4 and 5, the first and second electrodes 301 and 302 may be ITO-less electrodes. Namely, the first and second electrodes 301 and 302 may be bus electrodes shown in FIG. 2.

FIGS. 4 and 5 schematically show an exemplary structure of the first and second electrodes 301 and 302. Other structures may be used for the first and second electrodes 301 and 302.

The first area 310 may be a middle portion of the substrate 101, and the second area 320 may be an edge portion of the substrate 101. Namely, the first area 310 may be positioned between at least two second areas 320.

In a cross-sectional view taken along a direction crossing a longitudinal direction of the first and second electrodes 301 and 302 (i.e., a cross-sectional view taken along a dotted line A of FIG. 4), a cross-sectional shape of the first electrode 301 shown in (a) of FIG. 5 may be different from a cross-sectional shape of the second electrode 302 shown in (b) of FIG. 5. A cross-sectional area S1 of the first electrode 301 may be different from a cross-sectional area S2 of the second electrode 302. The cross-sectional area S1 of the first electrode 301 may be smaller than the cross-sectional area S2 of the second electrode 302.

When the cross-sectional area S1 of the first electrode 301 is smaller than the cross-sectional area S2 of the second electrode 302, generation of an erroneous discharge in the second area 320 may be suppressed.

The cross-sectional shape of the first electrode 301 may be a convex shape, and the cross-sectional shape of the second electrode 302 may be a polygon.

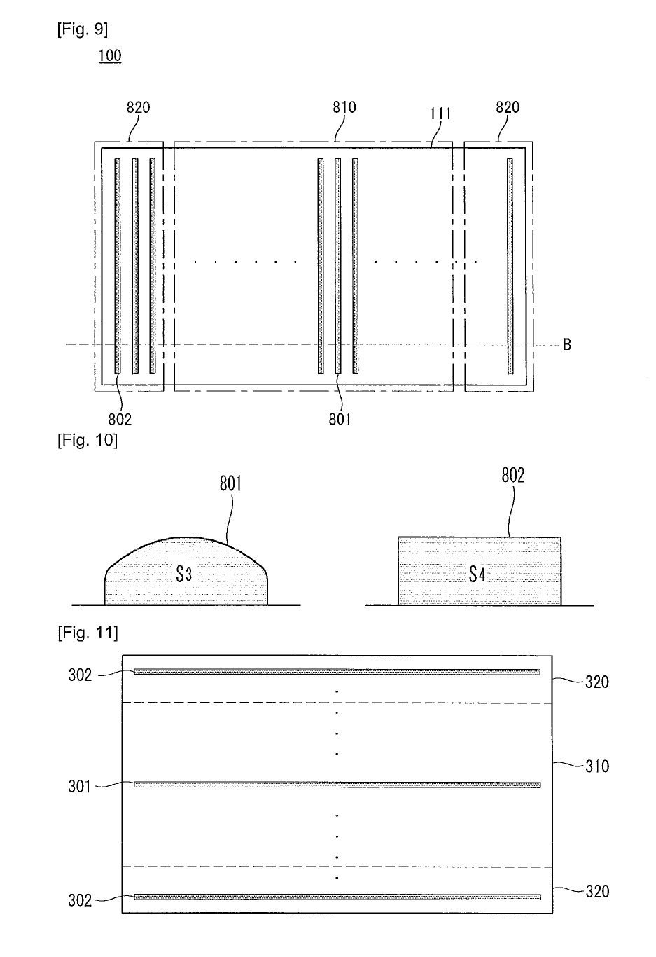

FIG. 6 illustrates a relationship between a cross-sectional area of an electrode and an erroneous discharge.

As shown in FIG. 6, the first and second electrodes 301 and 302 may be electrically connected to a driving device 520.

The driving device 520 may be positioned in the rear of a heat dissipation frame (not shown) positioned in the rear of the plasma display panel. The driving device 520 may be positioned at a location corresponding to a central portion of the panel. Therefore, a distance between the second electrode 302 and the driving device 520 may be greater than a distance between the first electrode 301 and the driving device 520. This may mean that a length of a second transmission line 500 electrically connecting the second electrode 302 to the driving device 520 is longer than a length of a first transmission line 510 electrically connecting the first electrode 301 to the driving device 520. Accordingly, an electrical resistance of the second transmission line 500 for supplying a driving signal to the second electrode 302 may be greater than an electrical resistance of the first transmission line 510 for supplying a driving signal to the first electrode 301. Hence, a voltage drop resulting from the second transmission line 500 may cause an erroneous discharge. More specifically, an intensity of a discharge generated in the second area 320 including the second electrode 302 may become excessively weaker by a voltage drop resulting from the second transmission line 500. For example, even if a driving signal is supplied to the second electrode 302, a discharge does not occur in the second area 320.

Furthermore, in case a temperature of the plasma display panel is higher than a normal temperature, an amount of wall charges may be insufficient because of a re-combination between wall charges inside the discharge cells. Hence, a discharge cell of the second area 320 to be turned on is turned off because of the voltage drop resulting from the second transmission line 500.

A luminance of an image displayed in the second area 320 including the second electrode 302 may be smaller than a luminance of an image displayed in the first area 310 including the first electrode 301 because of the voltage drop resulting from the second transmission line 500. In other words, the image quality may worsen because of a difference between the luminances of the image.

On the other hand, as shown in FIG. 5, when the cross-sectional area S2 of the second electrode 302 in the second area 320 is greater than the cross-sectional area S1 of the first electrode 301 in the first area 310, the electrical resistance of the second electrode 302 is less than the electrical resistance of the first electrode 301. Hence, the panel may be compensated for the voltage drop resulting from the second transmission line 500. Accordingly, the generation of erroneous discharge may be reduced, and the difference between the luminances of the image may be reduced.

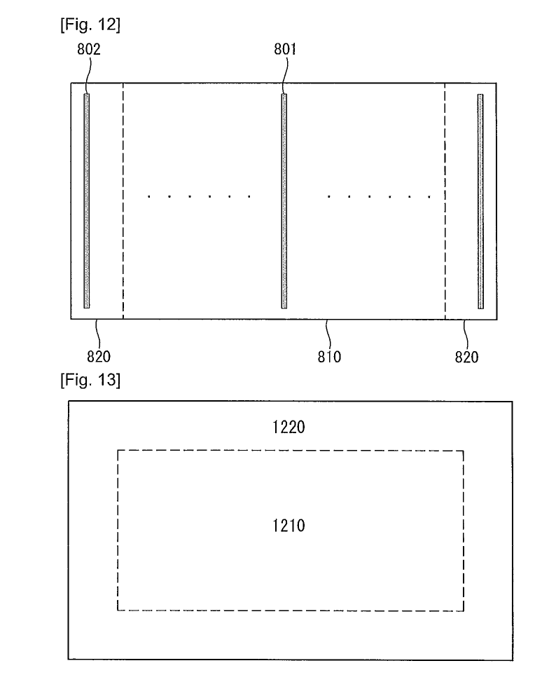

FIGS. 7 and 8 illustrate cross sections of first and second electrodes.

As shown in FIG. 7, when a middle portion and an edge portion of the first electrode 301 is called a first portion 600 and a second portion 610, respectively, a thickness t1 of a cross section of the first portion 600 may be greater than a thickness t2 of a cross section of the second portion 610. Namely, a cross-sectional shape of the first electrode 301 may be convex.

As shown in FIG. 8, a cross-sectional shape of the second electrode 302 may be a polygon. In a cross section of the second electrode 302, a thickness t4 of a second portion 710 outside a first portion 700 may be greater than the thickness t2 of the second portion 610. Namely, the thickness of the edge portion of the second electrode 302 may be greater than the thickness of the edge portion of the first electrode 301. A thickness t3 of the first portion 700 of the second electrode 302 may be substantially equal to the thickness t1 of the first portion 600 of the first electrode 301. A width W1 of the cross section of the first electrode 301 may be substantially equal to a width W2 of the cross section of the second electrode 302.

As described above, if the thickness t4 of the edge portion 710 of the second electrode 302 is greater than the thickness t2 of the edge portion 610 of the first electrode 301 in a state where the thickness t3 of the middle portion 700 of the second electrode 302 is substantially equal to the thickness t1 of the middle portion 600 of the first electrode 301 and the width W1 of the cross section of the first electrode 301 is substantially equal to the width W2 of the cross section of the second electrode 302, the cross-sectional area of the second electrode 302 may be greater than the cross-sectional area of the first electrode 301.

If the width W1 of the cross section of the first electrode 301 is different from the width W2 of the cross section of the second electrode 302, a viewer may perceive as if a stripped pattern is formed in a boundary portion between the first electrode 301 and the second electrode 302. Hence, the image quality may worsen.

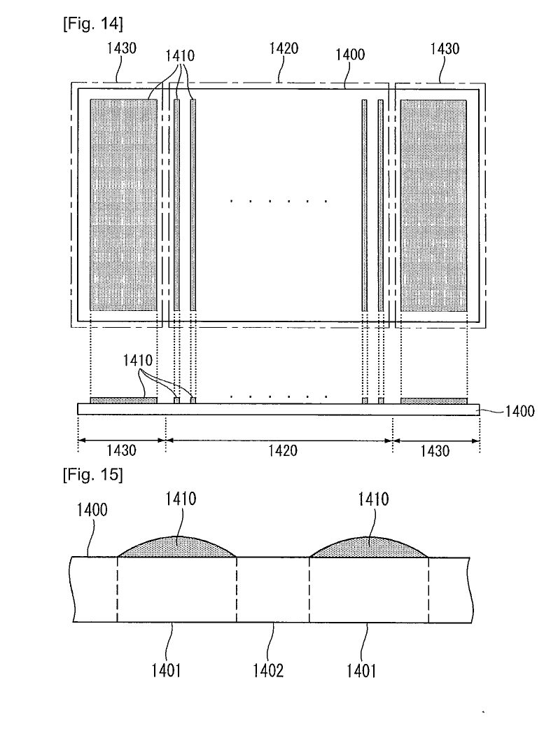

FIGS. 9 and 10 illustrate electrodes on a rear substrate. A description of a structure and a configuration identical or equivalent to those described above is briefly made or is entirely omitted in FIGS. 9 and 10.

A shown in FIGS. 9 and 10, cross-sectional shapes of first and second electrodes 801 and 802 on the rear substrate 111 may be different from each other. Preferably, a cross-sectional area S3 of the first electrode 801 in a first area 810 of the rear substrate 111 may be different from a cross-sectional area S4 of the second electrode 802 in a second area 820 of the rear substrate 111. More preferably, the cross-sectional area S4 of the second electrode 802 in the second area 820 may be greater than the cross-sectional area S3 of the first electrode 801 in the first area 810.

The first and second electrodes 801 and 802 may be the same kind of electrode. Preferably, the first and second electrodes 801 and 802 may be address electrodes.

The cross-sectional shape of the first electrode 801 may be convex. The first electrode 801 may have the same characteristics as the first electrode illustrated in FIGS. 4 to 8.

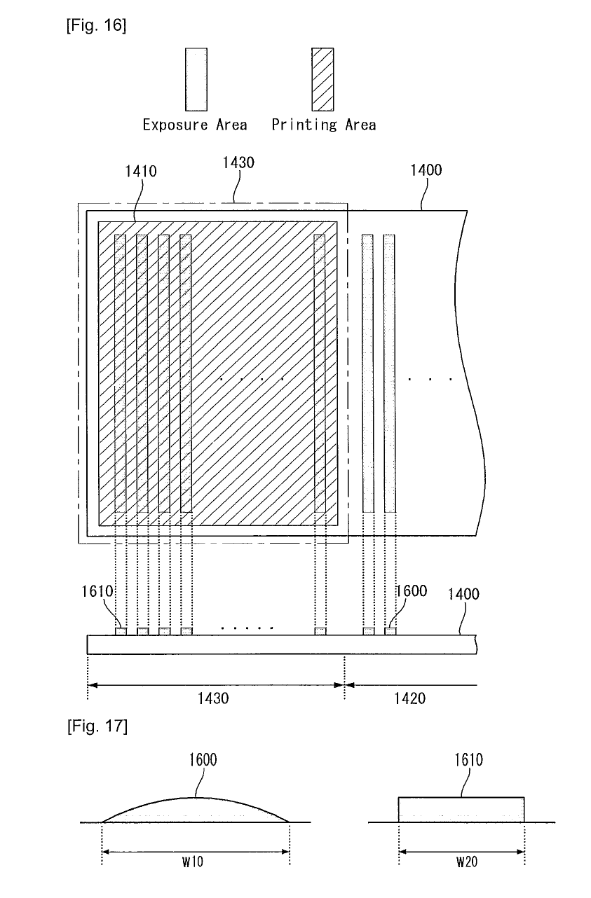

FIGS. 11 to 13 illustrate first and second areas.

In FIG. 11, first and second areas 310 and 320 may be distinguished from each other along a direction crossing a longitudinal direction of first and second electrodes 301 and 302. The first and second electrodes 301 and 302 may be scan electrodes, sustain electrodes, or bus electrodes as in FIGS. 4 to 8.

In FIG. 12, first and second areas 810 and 820 may be distinguished from each other along a direction crossing a longitudinal direction of first and second electrodes 801 and 802. The first and second electrodes 801 and 802 may be address electrodes as in FIGS. 9 and 10.

In FIG. 13, a substrate may be divided into a first area 1210 corresponding to a central portion and a second area 1220 corresponding to an edge portion surrounding the central portion, so as to include the configurations illustrated in FIGS. 11 and 12. More specifically, a cross-sectional shape of the scan electrode, the sustain electrode, or the bus electrode in the first area 1210 may be different from that in the second area 1220, and a cross-sectional shape of the address electrode in the first area 1210 may be different from that in the second area 1220.

In FIGS. 11 to 13, each of the second areas 320, 820 and 1220 may overlap a dummy area.

Further, each of the second areas 320, 820 and 1220 may overlap an active area as well as the dummy area. More specifically, the second electrodes 302 and 802, whose the cross-sectional areas are greater than the cross-sectional areas of the first electrodes 301 and 801, may be positioned in the active area as well as the dummy area under condition that the generation of erroneous discharge in an edge portion of the plasma display panel is suppressed.

The second areas 320, 820 and 1220 may correspond to a dummy area, and the first areas 310, 810 and 1210 may correspond to an active area.

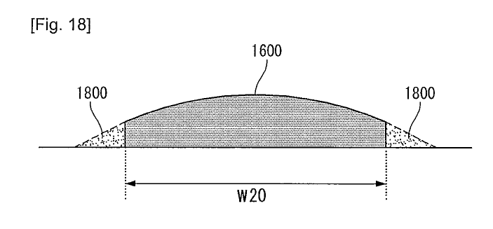

FIGS. 14 to 18 illustrate a method of manufacturing a plasma display panel.

As shown in FIG. 14, an electrode material 1410 may be printed on a first area 1420 of a substrate 1400 using a selectively printing method, and the electrode material 1410 may be printed on a second area 1430 of the substrate 1400 using a fully printing method. The substrate 1400 may a front substrate or a rear substrate. The electrode material 1410 may be a material for forming a scan electrode, a sustain electrode, a bus electrode, or an address electrode.

In the fully printing method, the electrode material may be coated on the whole of a predetermined area. In the selectively printing method, the electrode material may be coated on a selected area and may not be coated on a non-selected area.

For example, as shown in FIG. 15, in case the first area 1420 of the substrate 1400 is divided into a 10th area 1401 and a 20th area 1402 between at least two 10th areas 1401, the selectively printing method is performed to pint the electrode material 1410 on the 10th area 1401 and not to pint the electrode material 1410 on the 20th area 1402. Because the selectively printed electrode material 1410 has fluidity, the selectively printed electrode material 1410 may flow from its edge. Hence, the selectively printed electrode material 1410 may have a convex shape, and the first electrode formed of the selectively printed electrode material 1410 may have a convex shape.

The 10th area 1401 may be a formation area of the first electrode, and the 20th area 1402 may be an area between the two first electrodes.

In the fully printing method, the electrode material may be coated on a screen mask, and then the electrode material on the screen mask may be printed on the substrate 1400 using a squeezer.

In the selectively printing method, a direct printing method such as an offset method may be used.

Further, the screen mask may be changed in conformity with the shape of the first electrode, and then the selectively printing method may be performed using the changed screen mask.

Through the above-described methods, the electrode material may be selectively printed on the first area 1420 in conformity with the shape of the first electrode, and the electrode material may be entirely printed on the second area 1430.

In the process for printing the electrode material 1410, because the electrode material 1410 is selectively printed on the first area 1420, an amount of electrode material used may be reduced. Hence, the manufacturing cost of the panel may be reduced.

After the process for printing the electrode material 1410 is performed, the electrode material 1410 printed on the first and second areas 1420 and 1430 may be exposed.

For example, as shown in FIG. 16, the electrode material 1410 entirely printed on the second area 1430 may be exposed in conformity with the shape of the second electrode.

Because the electrode material 1410 in the first area 1420 is printed in conformity with the shape of the first electrode in the printing process, a photomask for the exposure does not need to have a pattern agreeable to the shape of the first electrode. On the other hand, the photomask may have a pattern agreeable to the shape of the first electrode so as to increase precision of the shape of the first electrode, and thus it is possible to expose the electrode material 1410 in the first area 1420 in conformity with the shape of the first electrode.

An exposure area and a printing area are shown in FIG. 16.

After the exposure process is performed, the electrode material printed on the first and second areas 1420 and 1430 is developed. Hence, as shown in FIG. 16, a first electrode 1600 may be formed in the first area 1420 and a second electrode 1610 may be formed in the second area 1430.

After the development process is performed, as shown in FIG. 17, the first electrode 1600 may have a convex shape, and the second electrode 1610 may have a polygon shape.

The convex-shaped first electrode 1600 is formed in the first area 1420 using the selectively printing method. Because the first electrode 1600 has the convex shape, a cross-sectional area of the second electrode 1610 may be greater than a cross-sectional area of the first electrode 1600.

When a width W10 of a cross section of the first electrode 1600 is greater than a width W20 of a cross section of the second electrode 1610, an edge portion of the electrode material printed on the 10th area 1401 may be partially etched in the development process. For example, as shown in FIG. 18, the width W10 of the cross section of the first electrode 1600 may be substantially equal to the width W20 of the cross section of the second electrode 1610 by partially etching an edge portion 1800 of the first electrode 1600.

It may be preferable that a percentage of an area of the second area based on a total area of the substrate is set at a predetermined value. The second area may correspond to at least one of the second areas shown in FIGS. 11 to 13.

The following Table 1 indicates when a percentage of an area P2 of the second area based on a total area P of the substrate changes from 1% to 50%, whether or not an erroneous discharge occurs and an amount of electrode material used. Silver (Ag) was used as the electrode material.

The erroneous discharge indicated in Table 1 may mean an erroneous discharge resulting from a phenomenon in which a cell to be turned on is turned off in a state where a predetermined image is displayed on the screen of the panel at a high temperature. A large number of observers observed the off-phenomenon of the cell to be turned on in a dark room to evaluate a state of the erroneous discharge.

In the following Table 1, X, ◯, and ⊚ represent bad, good, and excellent states of the characteristics, respectively. More specifically, in an erroneous discharge resulting from an off-phenomenon of a cell to be turned on at a high temperature, X represents that the erroneous discharge excessively occurs, and ⊚ represents that the erroneous discharge is completely prevented. In an amount of Ag used, X represents that a large amount of Ag is used, and ⊚ represents that the amount of Ag used is greatly reduced.

Table 1

TABLE 1

| P2/P | Erroneous Discharge | Amount of Ag used |
|---|---|---|
| 1% | X | ⊚ |
| 3% | ◯ | ⊚ |
| 5% | ⊚ | ⊚ |
| 10% | ⊚ | ⊚ |
| 15% | ⊚ | ⊚ |
| 20% | ⊚ | ⊚ |
| 25% | ⊚ | ◯ |
| 30% | ⊚ | X |
| 40% | ⊚ | X |
| 50% | ⊚ | X |

When a percentage of the area P2 of the second area based on the total area P of the substrate is 1%, the erroneous discharge may excessively occur. In this case, because the area P2 of the second area may be excessively small, it is difficult to prevent the erroneous discharge from being generated at an edge of the plasma display panel.

When a percentage of the area P2 of the second area based on the total area P of the substrate is 5% to 50%, the erroneous discharge may be completely prevented. In this case, because the area P2 of the second area may be sufficiently large, electrical resistances of the electrodes positioned an edge of the plasma display panel may be sufficiently reduced. Hence, the erroneous discharge may be prevented from being generated at the edge of the plasma display panel.

When a percentage of the area P2 of the second area based on the total area P of the substrate is 3%, the erroneous discharge may be properly prevented. In this case, the erroneous discharge may be generated at the edge of the plasma display panel. However, an influence of the erroneous discharge on the image quality of the plasma display panel may be negligible.

When a percentage of the area P2 of the second area based on the total area P of the substrate is 30% to 50%, the area P2 of the second area may be excessively large. Hence, because the amount of Ag used increases, the manufacturing cost may rise.

When a percentage of the area P2 of the second area based on the total area P of the substrate is 1% to 20%, the area P2 of the second area may be sufficiently small. Hence, because the amount of Ag used is sufficiently reduced, the manufacturing cost may fall.

When a percentage of the area P2 of the second area based on the total area P of the substrate is 25%, the amount of Ag used may be proper.

Considering the above Table 1, a percentage of the area P2 of the second area based on the total area P of the substrate may be 3% to 25% or 5% to 20%.

1. A plasma display panel comprising;
a substrate; and
a plurality of electrodes that are positioned substantially parallel to each other on the substrate, the plurality of electrodes including a first electrode in a first area of the substrate and a second electrode in a second area of the substrate outside the first area,
wherein a shape of a cross section of the first electrode is different from a shape of a cross section of the second electrode.

2. A plasma display panel of claim 1, wherein the cross sections of the first and second electrodes is taken along a direction crossing a longitudinal direction of the first and second electrodes.

3. A plasma display panel of claim 1, wherein the first and second electrodes are scan electrodes to which a scan signal is supplied during an address period of a subfield.

4. A plasma display panel of claim 1, wherein the first and second electrodes are sustain electrodes.

5. A plasma display panel of claim 1, wherein the first and second electrodes are address electrodes to which a data signal is supplied during an address period of a subfield.

6. A plasma display panel of claim 1, wherein the first and second electrodes are bus electrodes.

7. A plasma display panel of claim 1, wherein a cross-sectional area of the second electrode is greater than a cross-sectional area of the first electrode.

8. A plasma display panel of claim 1, wherein in the cross section of the first electrode, a thickness of a first portion of the first electrode is greater than a thickness of a second portion that is positioned closer to an edge of the first electrode than the first portion.

9. A plasma display panel of claim 8, wherein the shape of the cross section of the first electrode is convex.

10. A plasma display panel of claim 1, wherein a thickness of a second portion, that is positioned closer to an edge of the second electrode than a first portion in the cross section of the second electrode, is greater than a thickness of a second portion, that is positioned closer to an edge of the first electrode than a first portion in the cross section of the first electrode.

11. A plasma display panel of claim 10, wherein a thickness of the first portion in the cross section of the second electrode is substantially equal to a thickness of the first portion in the cross section of the first electrode.

12. A plasma display panel of claim 1, wherein a width of the cross section of the first electrode is substantially equal to a width of the cross section of the second electrode.

13. A plasma display panel of claim 1, wherein the first area is an active area of the substrate, and the second area is a dummy area of the substrate.

14. A plasma display panel of claim 13, wherein the second electrode is positioned in the active area and the dummy area of the substrate.

15. A plasma display panel of claim 1, wherein a percentage of an area of the second area based on a total area of the substrate is 5% to 20%.

16. A method of manufacturing a plasma display panel claimed in claim 1, comprising:
selectively printing an electrode material on the first area of the substrate and fully printing the electrode material on the second area of the substrate;
exposing the electrode material printed on the first area and the second area; and
developing the electrode material printed on the first area and the second area.

17. A method of claim 16, wherein selectively printing the electrode material comprises printing the electrode material on a 10th area of the first area and not printing the electrode material on a 20th area between two 10th areas.

18. A method of claim 17, wherein the 10th area is a formation area of the first electrode, and the 20th area is an area between the two first electrodes.

19. A method of claim 17, wherein developing the electrode material comprises partially etching an edge portion of the electrode material printed on the 10th area.
